(19) United States
(12) Patent Application Publication
(10) Pub. No.: US 2012/0303187 A1
(43) Pub. Date: Nov. 29, 2012

(54) SYSTEM AND METHOD FOR CONTROLLING RAIL VEHICLE CONSIST

(76) Inventors: Scott Joseph Sexauer, Lawrence Park, PA (US); Jennifer B. Young, Lawrence Park, PA (US); Bharath Kumar Reddy Vennela, Bangalore (IN)

(21) Appl. No.: 13/479,329

(22) Filed: May 24, 2012

Related U.S. Application Data
(60) Provisional application No. 61/490,621, filed on May 27, 2011.

(51) Int. Cl. G05D 1/02

(52) U.S. Cl. 701/19

(57) ABSTRACT

A system is provided including a control unit and an input unit. The control unit is configured to interface with a first vehicle in a vehicle consist, and to generate first control signals for controlling operations of at least one of the first vehicle or the vehicle consist based on a stored consist configuration data set including information regarding a distribution of vehicles. The control unit receives consist change information from the input unit. The consist change information includes positional information representative of a location of at least one change in the vehicle consist. The control unit is configured to use the consist change information to generate an updated stored consist configuration data set, and to generate additional, second control signals for controlling at least one of the first vehicle or the vehicle consist based on the updated stored consist configuration data set.

### RELATED APPLICATIONS

The present application claims priority to U.S. Provisional Patent Application Ser. No. 61/490,621, “System And Method For Controlling Rail Vehicle Consist,” filed May 27, 2011, the entire content of which is hereby incorporated by reference.

### TECHNICAL FIELD

Certain embodiments of the inventive subject matter described herein relate to vehicle control. Certain other embodiments relate to controlling rail vehicle consists.

### BACKGROUND

A vehicle “consist” is group of two or more vehicles mechanically coupled or linked together to travel along a route. For example, a rail vehicle consist is a group of two or more rail vehicles that are mechanically coupled or linked together to travel along a route, as defined by a set of rails that support and guide the rail vehicle consist. One type of rail vehicle consist is a train, which may include one or more locomotives (or other powered rail cars/vehicles) and one or more non-powered rail cars/vehicles. (In the context of a rail vehicle consist, “powered” means capable of self propulsion and “non-powered” means incapable of self propulsion.) Each locomotive includes traction equipment for moving the train, whereas each rail car is configured for hauling passengers or freight (for example).

Locomotives and other rail vehicles may include on-board control systems that present information to an operator, and/or automatically control the rail vehicle, rail vehicle consist, and/or sub-systems thereof, based on information about the rail vehicle, vehicle consist, or otherwise, that is entered into the control system by the operator. As a train or other rail vehicle consist traverses a route along a track, some vehicles of the vehicle consist (e.g., freight cars) may be periodically removed, and others may be added. Each time this happens, the operator is required to enter into the control system all the information about the new configuration of the rail vehicle consist. This is time intensive, and can lead to errors resulting from incorrect data entry and/or manual calculation by an operator. Additionally, the subsequently entered information may be less specific than that originally entered (e.g., weight summary versus weight distribution), and therefore less useful to certain control systems.

### BRIEF DESCRIPTION

In an embodiment, a system for controlling a vehicle consist comprises an operator interface, and also a control unit for a vehicle of the vehicle consist. The control unit is configured to control the vehicle consist based on a configuration data set, which relates to a configuration of the vehicle consist. (For example, the configuration may be a makeup of the vehicle consist, including the number and type of vehicles in the consist, weight, length, cargo type, and the like.) The control unit is further configured to control the operator interface to allow human operator entry of change data. The change data relates to vehicles and/or cargo that were added to and/or removed from the vehicle consist. (“Cargo” refers to anything potentially added to or removed from a consist other than the vehicles themselves, and may include passengers, freight, and fuel and other operational supplies.) The control unit is configured to store the configuration data set based on a prior data set (relating to a prior configuration of the vehicle consist) as modified by the change data.

Thus, according to one aspect, when the makeup of a vehicle consist is changed, such as removing or adding freight, or removing or adding vehicles to the consist, data of what has changed (e.g., the change data) is entered by an operator, and the system generates the configuration data set, for controlling the vehicle consist, by modifying the prior data set (e.g., the prior configuration data set) according to what has changed.

In an embodiment, the change data relates to less than the prior data set. That is, the change data relates to changes in the vehicle consist, but not to all data about the prior configuration of the vehicle consist. The prior data set is a prior version or iteration of the configuration data set, where “configuration” data set is used herein, according to one aspect of the inventive subject matter described herein, to refer to a superset of all data in the system about the vehicle consist that is available to the control unit.

In other embodiments, the control unit is configured to provide only certain modes for storing the configuration data set for use in controlling the vehicle consist. (For example, data entry modes may be restricted.) Such modes may include one or more of the following: machine or automatic entry of the configuration data set (such as through bar code entry), loading from a portable storage device, or signals received from a remote source; human operator entry of change data through the operator interface; human operator entry of the configuration data set through the operator interface; and/or human operator entry of the configuration data set through the operator interface but only subsequent to an initialization routine for “re-starting”/booting the control unit generally or in regards to a particular route or mission. In one embodiment, the control unit is configured to control the operator interface for human operator entry of data relating to the vehicle consist only as change data. In another embodiment, the control unit is configured to control the operator interface for human operator entry of data relating to the vehicle consist only as change data, and as the configuration data set subsequent to the initialization routine.

In an embodiment, a system comprises a control unit and an input unit. The control unit is configured to interface with a first vehicle in a vehicle consist having a plurality of vehicles, and to generate first control signals for controlling operations of at least one of the first vehicle or the vehicle consist based on a stored consist configuration data set that is representative of a configuration of the vehicles in the vehicle consist. The stored consist configuration data set includes information regarding a distribution of the vehicles in the vehicle consist. The input unit is operably coupled to the control unit, and the control unit is configured to receive consist change information from the input unit. The consist change information received from the input unit includes positional information representative of a location of at least one change in the vehicle consist, and the control unit is configured to use the consist change information to update the stored consist configuration data set and to generate additional, second control signals for controlling the operations of the at least one of the first vehicle or the vehicle consist based on the updated stored consist configuration data set.

In an embodiment, a method includes receiving, via an input unit, consist change information. The consist change information includes positional information representative of at least one location of a change to a vehicle consist. The method also includes updating, at a control unit of a vehicle of the vehicle consist, a previous configuration profile of the vehicle consist. The update is based on the consist change information to provide a new configuration profile. The previous and new configuration profiles include information regarding at least one of a distribution of vehicles or sequences of vehicles in the vehicle consist. The method further includes controlling the vehicle consist based on the new configuration profile.

In an embodiment, a non-transitory computer readable storage medium contains one or more sets of instruction that when executed by a control unit of a vehicle, cause the control unit to receive, via an input unit, consist change information that includes positional information representative of at least one location of a change to a vehicle consist including the vehicle. The control unit is also caused to update, based on the consist change information, a previous configuration profile of the vehicle consist to a new configuration profile. The previous and new configuration profiles comprise information regarding at least one of a distribution of vehicles or sequences of vehicles in the vehicle consist. The control unit is further caused to control the operation of the vehicle consist based on the new configuration profile.

### BRIEF DESCRIPTION OF THE DRAWINGS

The presently described inventive subject matter will be better understood from reading the following description of non-limiting embodiments, with reference to the attached drawings.

FIGS. 1 and 2 are schematic views of a system for controlling a rail vehicle consist, according to an embodiment of the presently described inventive subject matter.

FIG. 3 is a state table illustrating an aspect of an embodiment of the system.

FIG. 4 is a schematic view of another embodiment of a system for controlling a rail vehicle consist.

FIG. 5 provides a view of an embodiment of a change train screen.

FIG. 6 provides a view of an embodiment of a setout screen.

FIG. 7 provides a view of an embodiment of a pickup screen.

FIG. 8 illustrates a flowchart of an embodiment of a method for controlling a vehicle consist.

FIG. 9 provides a view of an embodiment of a prompt screen issued in response to an inconsistency with a rule.

### DETAILED DESCRIPTION

One or more embodiments of the inventive subject matter described herein relate to systems and methods for controlling a vehicle consist. While the figures and accompanying examples provided herein may focus on rail vehicles and rail vehicle consists, not all embodiments of the inventive subject matter are so limited. For example, the embodiments also may be used in conjunction with other vehicles or vehicle consists. In one embodiment, a system includes a control unit (for being disposed on-board a vehicle) and an operator interface. The control unit is configured to control a vehicle consist based on a configuration data set, which relates to the configuration of the vehicle consist. With respect to an example of a rail vehicle consist, the control unit may use the locations (e.g., distribution) of powered rail vehicles (e.g., locomotives) in the consist and, based on the locations, determine how to control the tractive efforts provided by the powered rail vehicles when the consist travels over various features in the terrain. As one example, the control unit may refer to the distribution of the powered rail vehicles in the consist to determine when to cause the powered rail vehicles to provide additional tractive effort and/or how much additional tractive effort is to be provided when the consist is traversing a crest, hill, or peak. The control unit is further configured to control the operator interface for human operator-entry of change data, which relates to vehicles and/or cargo that were added to and/or removed from the vehicle consist. The control unit generates the configuration data set by using the change data to modify a prior data set (relating to the configuration of the consist prior to the vehicles and/or cargo that were added to and/or removed from the vehicle consist). In this manner, operators can update the data set used to control the consist by (in effect) entering changes to the data, without having to re-enter all available data of the consist.

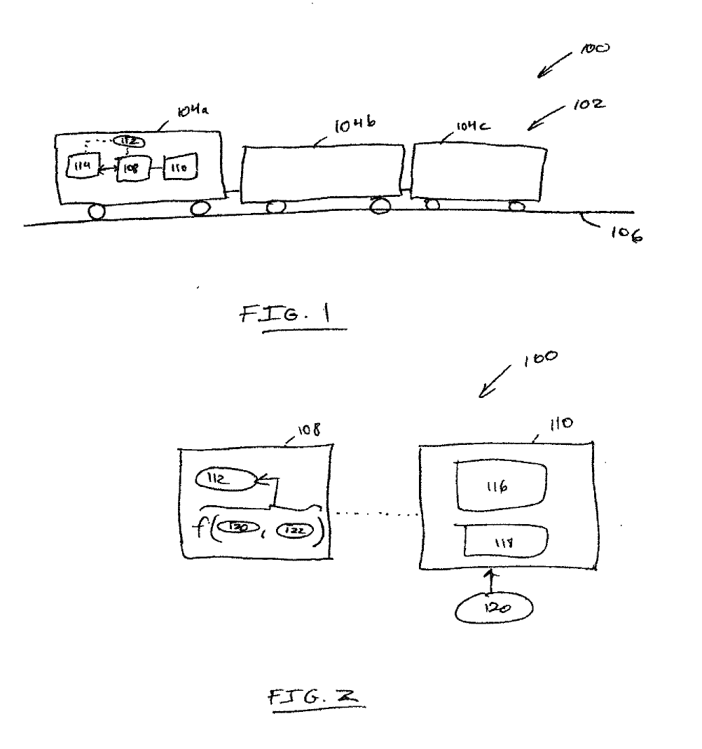

FIGS. 1 and 2 show an embodiment of a system 100 for controlling a vehicle consist 102. The vehicle consist 102 is shown in FIG. 1, and includes plural vehicles 104a, 104b, 104c (three vehicles are shown in FIG. 1, but the consist may have more or less vehicles) that are linked together to travel along a route 106, such as a track, road, waterway, and the like. As one example, the first vehicle 104a could be a locomotive, and the second and third vehicles 104b, 104c could be freight or passenger cars. The system 100 comprises a control unit 108 and an operator interface 110, both configured for deployment and use on a vehicle. The control unit 108 and operator interface 110 are shown installed for use in the consist in FIG. 1, and apart from the consist (e.g., in a condition for installation) in FIG. 2.

The control unit 108 is configured to control the vehicle consist 102 based (at least in part) on a configuration data set 112, which relates to a configuration of the vehicle consist. For example, the control unit 108 may be, or be part of or interfaced with, an energy management system 114 that creates a set of traction control instructions (e.g., brake and/or throttle settings) for controlling the vehicle consist along a route, based on available information about the vehicle consists as stored in the configuration data set 112. The control unit 108 may be a separate control unit specially provided as part of the system 100, or it may be a general purpose and/or existing control unit of a vehicle that is configured (e.g., using software) to act as part of the system 100. Broadly speaking, the control unit 108 is a hardware and/or software module configured to carry out the functions described herein, either alone or in conjunction with other elements. (Hardware and/or software module refers to one or more electronic components and/or sets of machine readable instructions, stored on a non-transitory medium, that perform or cause to be performed one or more designated functions.)

The operator interface 110 includes a data entry unit 116, which is configured for manipulation by a human operator to enter data. The operator interface 110 may also include a display 118 for displaying information to a human operator. For example, the data entry unit 116 may include one or more of a keyboard(s), switch(es), pointer device(s), softkey(s) or other touch screen panel(s) or functionality, and/or the like. The display 118 may comprise one or more of a tactile device(s), an LED(s) and/or other light emitting device(s), an LCD panel(s), CRT(s), or other monitor, and/or the like. The operator interface 110 may be an existing interface of a vehicle (e.g., part of an operator console), an interface provided specially as part of the system, and/or an interface that is controlled to perform functions of the system 100 and also functions of other systems. The operator interface 110 is operably interfaced with, or (prior to installation on a vehicle) configured to be operably interfaced with, the control unit 108, such as via a direct or indirect electrical connection.

The control unit 108 is configured to control the operator interface 110 for human operator-entry of change data 120 using the operator interface 110. Control may include controlling the operator interface to display certain prompts, data entry fields, or other information and/or graphics on the display 118, and/or controlling the operator interface to receive data from the data entry unit 116. The change data 120 relates to vehicles and/or cargo that were added to and/or removed from the vehicle consist 102. The control unit 108 generates the configuration data set 112 by using the change data 120 to modify a prior data set 122. The prior data set 122 relates to the configuration of the vehicle consist 102 prior to the vehicles and/or cargo that were added to and/or removed from the vehicle consist. The prior data set 122 and the configuration data set 112 are stored in a memory accessible by the control unit 108.

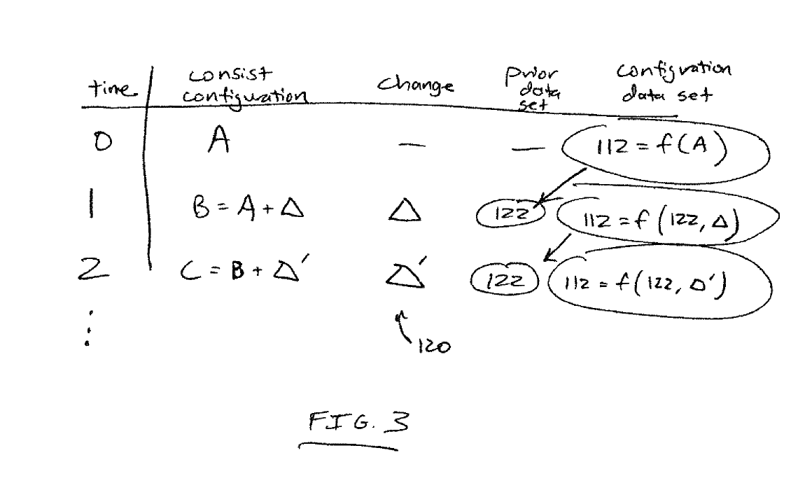

An example of this operation, as a function of time, is shown in FIG. 3. At a time 0, the vehicle consist 102 has an initial configuration “A.” Data of the configuration A is entered into the system 100, which is stored as the configuration data set 112. The system 100 may be configured for initial entry of the configuration data set 112 by one or more of the following: machine or automatic or semi-automatic entry of the configuration data set, such as through bar code entry, loading from a portable storage device, or signals received from a remote source, or by human operator entry of the configuration data set through the operator interface 110 or otherwise. Subsequent to time 0 but prior to time 1, the control unit 108 controls the vehicle consist based at least in part on the configuration data set 112 as it exists at time 0.

At time 1, the configuration of the rail vehicle consist has changed, for example by adding and/or removing vehicles and/or cargo from the consist. The change is indicated by Delta; thus, the new consist configuration “B”=A+Delta (Delta potentially having both additive and subtractive components). The control unit 108 controls the operator interface 110 to allow human operator entry of change data 120 (=f (Delta)) into the system. Once the change data 120 is entered and available, the control unit 108 generates the configuration data set 112 (for storage in memory) by modifying the previous configuration data set (e.g., which is now the prior data set 122) according to the change data 120. Subsequent to time 1 but prior to time 2, the control unit 108 controls the vehicle consist based at least in part on the configuration data set 112 as it exists at time 1. At time 2, the vehicle consist is again changed (Delta prime), and the process continues similarly as above.

In one aspect, the change data 120 relates to less than the prior data set 122. That is, the change data 120 relates to changes (Delta) in the vehicle consist 102, but not to all the data 122 about the prior configuration of the vehicle consist. Thus, in an embodiment, the system 100 is configured to generate and store a configuration data set 112, for controlling the consist, by modifying the prior data set 122 according to a subset of the prior data set 122. The configuration data set 122, therefore, is a superset of all data in the system about the vehicle consist available to the control unit 108. By generating configuration data sets 122 using change data 120, this obviates the need to regularly or periodically enter data about the entire vehicle consist, as would be time intensive and might result in data entry errors.

In an embodiment, the system 100 is configured to limit the modes by which data may be entered and/or configuration data sets generated or stored. For example, the control unit 108 may be configured to control the operator interface 110 for human operator-entry of data, or certain types of data, only at certain times or under certain conditions (e.g., pre-determined times or conditions).

In one aspect, the system 100 is configured for one or more of the following data entry modes when the system 100 is initially used (e.g., time 0 in FIG. 3): machine (automatic or semi-automatic) entry of the configuration data set, such as through bar code entry, loading from a portable storage device, or signals received from a remote source; and/or human operator entry of the configuration data set through the operator interface. “Initially used” may include time subsequent to an initialization routine for “re-starting”/booting the control unit generally or in regards to a particular route or mission. Other modes are possible. In another aspect, the system 100 is configured in one of the following ways for human operator data entry and subsequent system processing (as relating to entering data of a configuration of the consist which is used as the basis for consist control) outside of an initial use or subsequent initialization: human operator-entry of change data through the operator interface only (in other words, outside of initial use or subsequent initialization, the only option provided by the system for human operator entry of data, as relating to entering data of a configuration of the consist which is used as the basis for consist control, is as change data through the operator interface); or human operator-entry of change data through the operator interface and human operator-entry of a configuration data set through the operator interface only. An option for machine entry (automatic or semi-automatic) of data may or may not be provided.

In one aspect, by allowing an operator to enter only the details of the changes made to a rail vehicle consist, this addresses two problems: i) the details of pickup (add) and setout (remove) operations can be entered directly from the paperwork generally available to the operator, eliminating manual calculations and/or re-entry of information previously entered; and ii) the details of the parts of the rail vehicle consist that are not affected are retained, resulting in higher-fidelity input to the control algorithms/systems of the consist. In contrast, in certain known systems where an operator re-enters all information regarding a rail vehicle consist, an undesirably large amount of detail regarding the configuration of the consist may be lost.

In one aspect, when vehicles are added to or removed from an existing vehicle consist, the operator is given a method to enter only the specifics of the changes being made. Details of the vehicle consist are recalculated without requiring the operator to perform manual calculations. In an embodiment, an on-board control system retains a mathematical model of a vehicle consist, including details of existing consist makeup (such as individual car/vehicle length, weight, and axle count). The operator is then allowed to enter specific changes to the vehicle consist (e.g., “remove these x cars from the rail vehicle consist,” “add y cars to this position in the rail vehicle consist”). The on-board control system then builds a new model of the vehicle consist, based on the initial model and the changes made to it. This allows not only for the retention of previously entered detail, but also improvement of the level of positional and/or distributional detail for the newly entered information.

In an embodiment, the control unit is configured to control the operator interface to allow the operator to indicate block(s) of vehicles (of the vehicle consist) to be moved, without requiring manual entry of all new data of the consist configuration. The control unit then automatically recalculates consist totals and/or distributed power locomotive position. The system retains weight distribution information (e.g., a model or representation of how weight is distributed among different locations and/or vehicles in the consist along a length of the consist). Pickups and setouts can be done in any order; multiple pickups and/or multiple setouts can be done at a siding.

In an embodiment, the control unit is configured to control the operator interface for an operator to enter change data by identifying particular vehicles of the consist by respective identifiers, and by identifying sequences of vehicles in the consist using identifiers or sequence numbers, for removal from the configuration data set. More specifically, by interacting with the operator interface (as controlled by the control unit), the operator identifies one or more vehicles of the consist for removal/setout. (For example, the control unit may be configured to control the operator interface for the operator interface to provide an option for the operator to select a removal or setout mode. Upon selecting the mode, the control unit then controls the operator interface for allowing the operator to enter or select particular vehicles of the consist or sequences of vehicles.) Information of the selected vehicles (this information being, in effect, change data) is then communicated to the control unit. The control unit correlates the identified vehicles to corresponding data in the current configuration data set. The control unit generates a new configuration data set by removing the correlated data of the selected vehicles from the current configuration data set, and possibly by otherwise processing the new configuration data set, e.g., weight re-distributions. The setout screen 600, discussed in greater detail below, is an example of an input unit that may be used with such a control unit.

In an embodiment, the control unit is configured to control the operator interface for an operator to enter change data by providing information about vehicles to be added to the configuration data set. More specifically, by interacting with the operator interface (as controlled by the control unit), the operator identifies one or more vehicles to be added to the consist and provides information about the vehicles. (For example, the control unit may be configured to control the operator interface for the operator interface to provide an option for the operator to select an addition or pickup mode. Upon selecting the mode, the control unit then controls the operator interface for allowing the operator to enter information identifying the vehicles be added and/or information about the vehicles, such as weight, length, and sequence position.) Information of the added vehicles (this information being, in effect, change data) is then communicated to the control unit. The control unit generates a new configuration data set by adding the data of the added vehicles to the current configuration data set, and possibly by otherwise processing the new configuration data set, e.g., weight re-distributions. The pickup screen 700, discussed in greater detail below, is an example of an input unit that may be used with such a control unit.

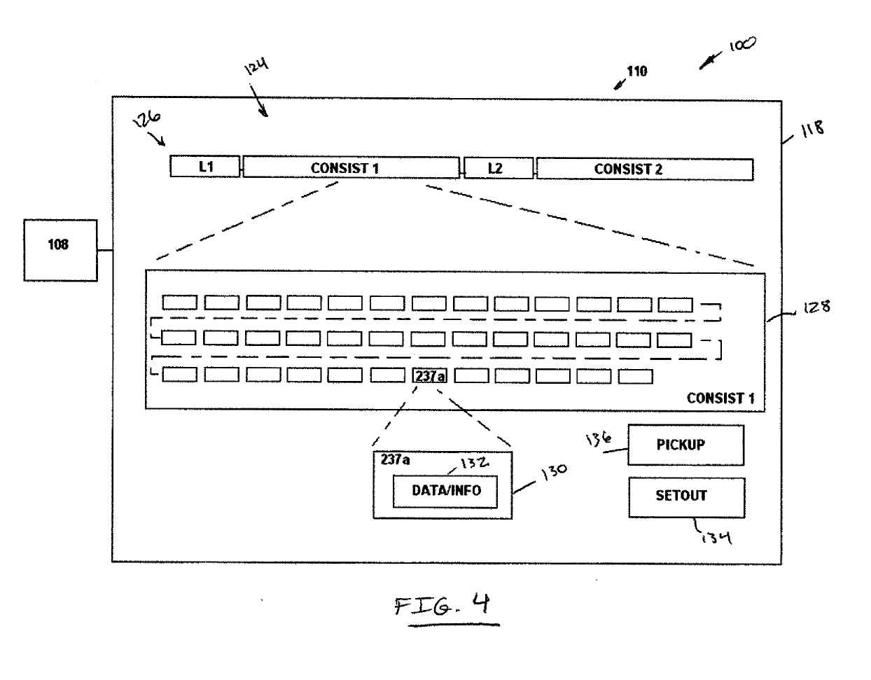

Aspects of the system 100 can be implemented as a graphical user interface. With reference to FIG. 4, in an embodiment of the system 100, the control unit 108 is configured to control the display portion 118 of the operator interface 110 for displaying various graphical elements 124 that correspond to (i) data stored in a memory of the control unit, (ii) portions of the rail vehicle consist 102, (iii) etc. For example, in the embodiment shown in FIG. 4, the control unit 108 controls the display 118 for displaying a consist view 126, which is graphical representation of the overall rail vehicle consist. The consist view 126 includes graphical sub-elements 124 that correspond to locomotive (or other powered rail vehicle or vehicle) consists L1, L2 in the vehicle consist, and graphical sub-elements 124 that correspond to freight car (or other non-powered rail vehicle or vehicle) consists “Consist 1”, “Consist 2”. The consist view 126 is generated based on data stored in memory of the control unit, e.g., a configuration data set 112 of the rail vehicle consist. The display 118 may have touch screen functionality, or an operator is otherwise able to select portions of the graphically displayed consist view, such as by using a pointer device to move a cursor.

The control unit and/or display are configured to respond to the operator selecting a portion of the consist view 126, by expanding the selected portion of the consist view 126 into a graphically displayed sub-consist view 128. For example, as shown in FIG. 4, an operator has selected “Consist 1”, which has resulted in the display of a sub-consist view 128 for “Consist 1”. The sub-consist view 128 includes graphical sub-elements 124 that correspond to all the individual rail vehicles within the sub-consist in question, here, “Consist 1.” The sub-consist view 128 includes an identifier for identifying the sub-consist with which it is associated, and the individual graphical elements representing the rail vehicles of the consist may include identifying indicia also (e.g., as shown in FIG. 4, one of the vehicles has indicia “237a”). The sub-consist view 128 is generated based on data stored in memory of the control unit, e.g., a configuration data set 112 of the vehicle consist.

The control unit and/or display are configured to respond to the operator selecting a portion (individual vehicle) of the sub-consist view 128, by expanding the selected portion of the sub-consist view 128 into a graphically displayed individual vehicle view 130. The individual vehicle view 130 includes data/information 132 about the individual vehicle in question. Again, the individual vehicle view 130 is generated based on data stored in memory of the control unit, e.g., a configuration data set 112 of the vehicle consist.

In the embodiment of the system 100 as shown in FIG. 4, the system is further configured for the control unit 108 to control the display portion 118 of the operator interface 110 for displaying various graphical elements 124 that correspond to control functions 134, 136. The control unit and/or display are configured to respond to an operator selecting one of the control functions, by performing a designated function associated with the selected control function. For example, in regards to a “setout” control function 134, upon an operator selecting this function (e.g., touchscreen), the system allows the user to select one or more of the individual vehicles of the sub-consist currently displayed. Upon the operator again selecting the “setout” control function 134, the control unit re-configures the configuration data set 112 as described above, for removing the setout-selected vehicles from the configuration data set of the rail vehicle consist. Of course, this would typically be associated with the operator actually controlling the vehicle consist for the selected vehicles to actually be removed from the consist.

The control unit may be configured for various sub-screens and/or intermediate screens to be shown in conjunction with such a function, such as displaying safety warnings, allowing for revisions and “undo/redo”, or the like. As another example, the system may be configured with a “pickup” control function 136, which would allow for entering data of vehicles to be entered into the consist, and operator graphical selection of where in the overall consist the new vehicles will be positioned.

Certain embodiments of user interfaces are discussed above. In additional embodiments, different types of input units may be used alternatively or additionally to the above discussed user interfaces. For example, other types of user interfaces may be used. Further, embodiments may include automatic data entry units as an input unit, or as one of a number of devices used as an input unit or system. One example of an automatic data entry unit is a bar code reader, that could read a bar code associated with vehicles being added or removed from a consist. As another example, vehicles of a rail vehicle consist may include Automatic Equipment Identification (AEI) tags, for example, an RFID chip, that is recognized by readers along the track traveled by the rail vehicle consist. This information may be controlled by a system external to the rail vehicle consist's control system, but the control system could access the external system to obtain such information.

The information from the automatic data entry unit may supplement, confirm, and/or replace information entered via a user interface. For example, a bar code reader may provide detailed information about the type and contents of a car, while the operator inputs the position of the car via a user interface. As another example, information at a lower level of detail may be initially added via a user interface at the adding/removing of vehicles from a consist, with the control unit using this information to revise a trip plan or other control plan based at least in part on distributional aspects of the vehicle consist. Then, at a subsequent time, the consist may pass an AEI reader, at which point the control unit may access more detailed information from the AEI system, and use the more detailed information to again determine a revised trip plan. As used herein, a “trip plan” may include designated operational settings of a vehicle consist to travel along one or more routes for a trip to a destination location. The trip plan can designate tractive settings (e.g., power outputs, speeds, and the like) and/or braking settings (e.g., degrees at which brakes are applied) as a function of distance along the routes and/or time of the trip. The trip plan may be formed to cause the consist to travel to a destination location at a scheduled time and/or to reduce the amount of fuel consumed, emissions generated, time spent traveling along in the trip, and the like, relative to the consist traveling along the routes according to one or more other operational settings. The trip plan can be created based on a variety of inputs and factors, such as a size of the consist, a weight of the consist, a weight distribution of the consist, a distribution of powered vehicles (e.g., those vehicle capable of self-propulsion), curvature of the routes, grades of the routes, anticipated weather conditions, power outputs from the tractive components (e.g., motors) of the consist, and the like.

As another example of information input, in certain embodiments at least a portion of the changes to the consist along its route may be known in advance, and saved in a data storage system as a work order. Each such work order is identified by a unique identifier, for example, an alphanumeric code. For example, one work order might involve the removal of a given sequence of vehicles at a specified stop, and be identified in the data storage system as “Work Order ABC123.” Then, at the specified stop, the operator may setout, or remove, that particular sequence. Instead of having to enter details about the particular sequence, the operator merely has to, for example, select or enter “Work Order ABC123” into a user interface. The control unit can then access the details of that particular work order, identify the change or changes to be made and the location of that change or changes within the consist, and adjust the vehicle consist configuration appropriately. The control unit may also provide the operator with a prompt describing the work order to facilitate confirmation that the correct adjustments are being made. In the event of an inconsistency, or the inability to access the work order, the operator may hand enter information about the modification being made.

The level of detail included as part of change information entered, or input, may vary between embodiments, as appropriate. Generally speaking, more detailed input will result in improved calculations and/or control planning based on the profile of the consist configuration, but will require more effort from an operator and potentially be subject to increased data entry errors or inconsistencies. Generally speaking, less detailed input will result in less accurate calculations and/or control planning, but will reduce operator effort and the opportunity for data entry errors. Additional methods of adding information or inputting data are also contemplated. For example, in FIG. 4 discussed above, a vehicle consist is depicted in a graphical representation. In alternate embodiments, such as certain embodiments discussed below, information may be entered in tabular fashion, or, in other embodiments, in another fashion, for example in response to prompts provided by a control unit, or in other embodiments, by entry by an automated data entry unit. Different combinations of data entry methods may also be used in conjunction with each other as well.

Generally speaking, certain embodiments provide methods and systems for entering or inputting information regarding changes to the configuration of a vehicle consist, including positional or distributional information regarding the location or position of changes to the vehicle's configuration (e.g., specific locations and characteristics of vehicles added and/or removed from the consist). The positional information provides information on not just what has changed, but also where changes have occurred, thereby allowing for more accurate updating of configuration information describing the vehicle consist and/or more accurate re-computation or development of settings based on distributional information of the vehicle.

For example, a control unit may devise and implement a trip plan at an initialization point that factors in specific distributional information about a vehicle consist. In some systems, once changes are made at stops made by the vehicle consist, the initial configuration information may be essentially thrown away, and new information entered by an operator, with the new information providing only general summary information without having additional detail about the distribution of weight along a length of the consist. The trip plan may now be re-determined based on the new summary information, but such a trip plan or other control scheme will be of reduced quality due to the lack of detail of distributional or positional information about the consist. For example, handling and/or braking of the vehicle consist may be significantly impacted based on a new weight distribution resulting from the changes, but the control unit in such systems is not provided with the required level of detail to adjust accordingly.

Embodiments, such as those discussed herein, provide for improved updating of configuration profiles and improved control based on those configurations. For example, in one or more embodiments, at each stop of the consist, the initial, or prior, configuration is generally retained, and modified only by change information that includes positional information regarding the changes made. By retaining the information for the portions of the consist that do not change, the control system does not lose detail on those aspects of the consist. And, by inputting change information including positional information for the newly added and/or removed vehicles, the control system is provided with improved information regarding the changes, resulting in improved control. Further still, by requiring only entry of information regarding the changes made, the operator may be spared the effort of calculating and re-entering information regarding the entire consist. Thus, embodiments provide improved levels of detail in information used to control the consist, while at the same time simplifying data entry for changes made to the vehicle consist.

The positional information may be used with external systems, such as systems other than control system for the particular vehicle consist. For example, the improved vehicle consist configuration information could be shared with other systems for planning the activities of multiple vehicle consists on a network of routes, for example, to a dispatching system and/or other system for selecting or assigning alternate routes based on revised vehicle consist characteristics. Vehicle consist configuration information may also be sent to, for example, tracking systems.

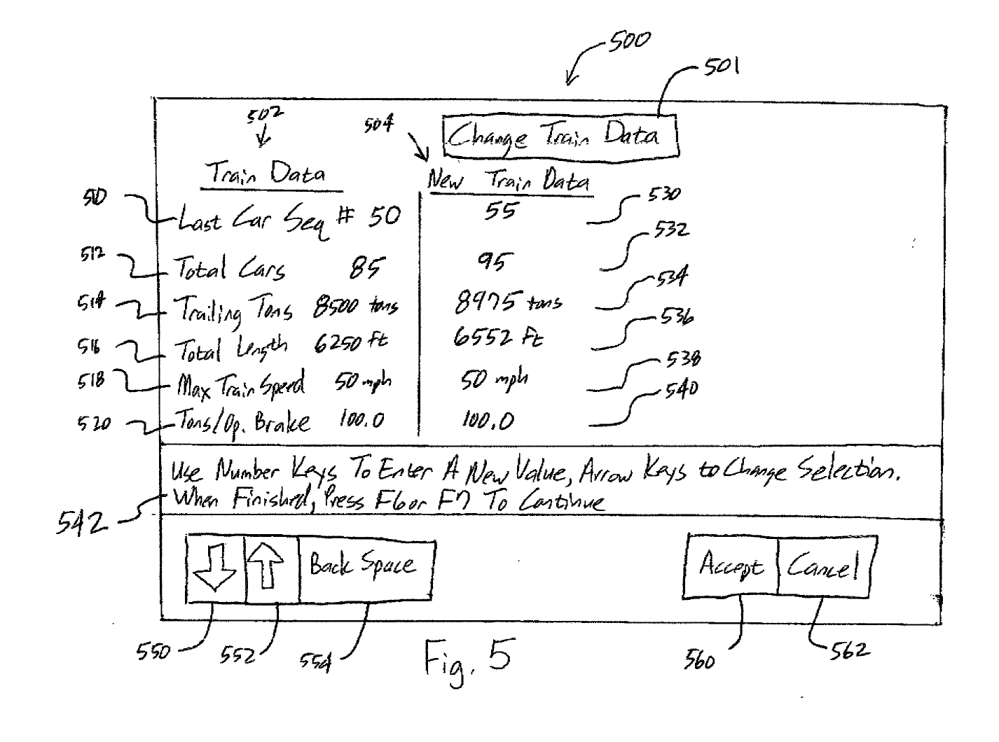

In one or more embodiments, an operator may start at a main screen and/or vehicle consist set up screen, and select a tab to move to a screen or other format for changing train configuration. The tab selection may be made, for example, by touching a tab or panel on a touch screen, identifying the tab using a cursor, and/or depressing a corresponding function key or other key on an associated keyboard or keypad. An example of such a screen for changing train configuration data is shown in FIG. 5. FIG. 5 illustrates a Change Train Screen 500 formed in accordance with an embodiment. The Change Train Screen 500 includes a title block 501 (“Change Train Data”) that alerts an operator to the designated purpose or functionality of the screen. On this screen, for example, data regarding changes to an overall configuration of the vehicle consist may be entered and/or displayed. Thus, while a system already has the beginning, or prior, vehicle consist configuration (including, for example, information regarding the sequences of vehicles, including the number, weight, and length of vehicles in each sequence and the positions of both the sequences within the consist and the vehicles within the sequences), screen 500 may be used to help change the configuration to account for changes made to the vehicle consist.

For example, the Change Train Screen 500 includes an existing data column 502 and a new data column 504. In the depicted embodiment, the existing data column 502 is a “Train Data” column representing a pre-existing condition of a rail vehicle consist, and the new data column 504 is a “New Train Data” column representing a new condition of a rail vehicle consist. Each column contains corresponding rows of data for particular aspects of a vehicle consist configuration. For example, the existing data column 502 includes first data 510, second data 512, third data 514, fourth data 516, fifth data 518, and sixth data 520. The new data column includes first data 530, second data 532, third data 534, fourth data 536, fifth data 538, and sixth data 540. In the depicted embodiment, the respective data in each column describe a similar parameter or category of information. Thus, the first data 510 of the existing data column 502 corresponds to the first data 530 of the new data column 504, and so on. By selecting or entering a different value for a particular data category in the new data column 504 from the corresponding entry in the existing data column 502, a new configuration may be entered.

A screen such as screen 500 can be utilized to enter a change, and/or can summarize a change entered on other more detailed screens. In the depicted embodiment, the first data 510, 530 are for “Last Car Seq #.” In this embodiment, a car sequence number is a number assigned to a car or group of cars based on the sequence of that car or group of cars along the length of the rail vehicle consist, with the first sequence labeled “1” and each following sequence identifier increasing by one integer. Because some of the sequences may have more than one car, the total number of cars may differ from the total number of sequences. For example, a group of associated cars that will remain coupled together as long as all are part of the moving rail vehicle consist, and will be picked-up and/or set out (removed) from the rail vehicle consist at the same time, may be grouped as a single sequence number for convenience.

As an example, a locomotive at the head of a rail vehicle consist may be assigned sequence number 1. A single cargo car may be sequence number 2. Then, a group of 3 cargo cars that will remain associated throughout the trip may be sequence number 3. A single cargo car may follow those in the rail vehicle consist, and be sequence number 4 (this car, of course, is the sixth car in the rail vehicle consist because sequence number 3 contained 3 cars). Additional sequences of, for example, locomotives, single cargo (and/or passenger) cars, or multiple cargo (and/or passenger) cars may be added. In other embodiments, locomotives may not be labeled, or be identified differently, so that, for example, sequence 1 would correspond to the first (or most forwardly located) cargo car. In other embodiments, sub-consists may be used, for example one or more sub-consists of locomotives and one or more sub-consists of non-powered vehicles. In still other embodiments, other identification schemes may be employed.

In the depicted embodiment, second data 512, 532 describes the total number of cars in the vehicle consist. As discussed above, the total number of cars may be different than the total number of sequences. Third data 514, 534 describes the trailing tons of the vehicle consist. Fourth data 516, 536 describes the total length of the vehicle consist. These first through fourth data categories generally correspond to physical or structural characteristics of the vehicle consist. In the illustrated embodiments, changes have been made to add 5 sequences having a total of ten cars. The added sequences add 475 tons to the trailing tons and 302 feet to the length of the consist.

Other data categories may correspond to performance characteristics, or desired performance characteristics of the rail vehicle consist. For example, in the depicted embodiment, fifth data 518, 538 describes the maximum train speed, and sixth data 520, 540 describes the Tons/Op. Brake. These, or other data categories, may be entered separately, calculated based on other entries and/or other processing, or by a combination of the two. In the illustrated embodiment, fifth data 518, 538 and sixth data 520,540 are unchanged.

The screen 500 also includes directional note 542. The directional note 542 provides instructions on how to use the screen. In the depicted embodiment, the directional note 542 states, “Use Number Keys To Enter A New Value, Arrow Keys to Change Selection. When Finished, Press F6 or F7 To Continue.” The directional note 542 prompts a user how to enter or select values, and may include prompts, for example, on how to use a corresponding keypad, touch screen, or combination of the two.

The screen 500 also includes navigation tabs 550, 552, 554. For example, in the depicted embodiment, navigation tab 550, represented by a downwardly pointing arrow, allows a user to scroll downwardly through the various data entry rows, while navigation tab 552, represented by an upwardly pointing arrow, allows a user to scroll upwardly through the various data entry rows. Navigation tab 554 is a backspace function allowing modification of an entry that an operator desires to change.

The screen 500 also includes confirmation tabs 560, 562 that are configured to allow an operator to have entered values accepted (or rejected) by the system, where, for example, they may be used by a trip planning system to re-calculate and/or adjust the control of the rail vehicle consist. Confirmation tab 560 is an “Accept” tab that, when selected, accepts the entered information showing on the screen and forwards on to the appropriate systems for use of the newly entered information. Confirmation tab 562 is a “Cancel” tab that, when selected, removes the newly entered information and/or reverts to the previously entered information.

In alternate embodiments, more, less, or different data categories may be identified by and/or adjusted through use of a change vehicle screen or other input unit.

As indicated above, a screen or other user interface or input unit may be used to enter changes; display changes from another screen or screens; display values calculated by, for example, a control unit; or a combination thereof. Changes entered on pickup and/or set out screens (examples of which are discussed in greater detail below) and performance changes made on a change data screen may be performed separately on separate screens. In other embodiments, for example, single screens may contain combinations of screens discussed herein, or data may be entered via subscreens, popup windows, and/or other input methods, such as automatic data entry units, discussed above

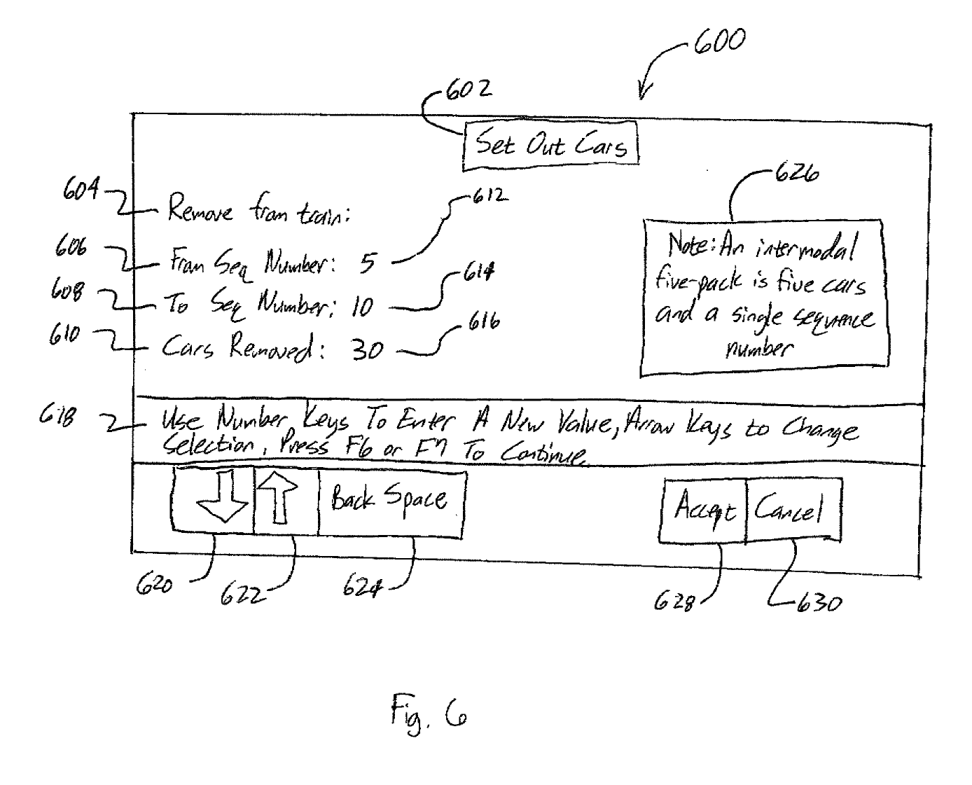

FIG. 6 illustrates an example of a setout screen 600 formed in accordance with an embodiment. The setout screen 600 is used to enter information about cars and/or groups of cars that are being removed, or setout, from the vehicle consist. The setout screen 600 includes a title 602, a removal prompt 604, removal data labels 606, 608, 610, and removal data entries 612, 614, and 616. The setout screen 600 also includes a directional note 618, navigation tabs 620, 622, 624, an information note 626, and confirmation tabs 628 and 630. As with other screens discussed herein, different amounts and/or forms of data and/or directional notes and/or navigation tabs and/or informational notes and/or confirmation tabs may be used in different embodiments. The title 602 is located at the top of setout screen 600 and provides a reminder to the operator or data enterer of the function of the screen. In the depicted embodiment, the title 602 is “Set Out Cars.”

Removal prompt 604 is located at the top of a column of categories for entry of data, and indicates to the operator where to enter the pertinent data. For example, in the depicted embodiment, the setout screen 600 includes first data label 606 (“From Seq Number”), second data label 608 (“To Seq Number”), and third data label 610 (“Cars Removed”). Each data label 606, 608, and 610 has a corresponding data entry 612, 614, and 616.

For example, in the illustrated embodiment, the first data entry 612, which corresponds to the first data label 606, has been entered with a “5,” indicating that the most forward sequence to be removed is sequence 5. Again, from above, a system associated with the rail vehicle consist (such as a control unit discussed above) would already have the information, or access to the information, to identify and describe sequence 5 from an initial rail vehicle consist configuration, or other prior configuration, previously established.

Further, in the illustrated embodiment, the second data entry 614, which corresponds to the second data label 608, has been entered with a “10,” indicating that the most rearward sequence to be removed is sequence 10, as previously identified. Thus, sequences 5, 6, 7, 8, 9, and 10 would be removed in the depicted example. In other embodiments, the information may be entered in rearward to forward order, or may be entered by entering the two sequences numbers on the boundary of the block being removed without respect to which is forward or rearward (as a system may already have this information based on the previous configuration).

The third removal data entry 616, which corresponds to the third data label 610, is “30” in the illustrated embodiment. This indicates that there are 30 cars in the sequences 5-10 being removed. This data category may serve as a useful double-check on the sequence data being entered. For example, the operator may enter all three categories. Then, the control system, because it can calculate the number of cars value based on the configuration information already available to it (including information on the number of cars in each removed sequence), can double-check the operator's entry and provide a prompt if the entries are inconsistent. Or, the control unit may automatically fill out the number of cars based on the entered sequences allowing the operator to visually check for confirmation, and/or may provide a prompt asking the operator whether or not the automatically filled in information is correct.

Similarly, the numbers of car information may be entered along with a beginning sequence number, with the control unit automatically filling in the other sequence number, and/or requesting confirmation (for example, by a pop-up screen) from the operator of the automatically filled in number. Thus, using information regarding the existing consist configuration, a control unit may be able to automatically complete certain blocks of information based on entries made by an operator for other blocks of information. Confirmation may also be obtained additionally or alternatively through the use of the confirmation tabs 628 and 630 discussed below. Thus, an operator may enter all of the data entries on a particular screen or other input unit, or, in other embodiments, certain of the entries may be automatically filled by an associated system, unit or processor.

The first data entry 612 and second data entry 614, for example, contain positional, or distributional, information. By identifying specific sequence numbers associated with positions in the existing configuration of the vehicle consist, these positional data entries provide positional information that allows the system to adjust to the new configuration not only by adjusting for a change in overall length and/or weight, but also in the position, or distribution of the lengths and weights of the various vehicles or groups of vehicles associated with the new configuration. For example, in systems where a trip plan is calculated based on the distribution information of a vehicle consist, aspects of that information become lost if only entries in overall length and weight of the vehicle consist are entered. However, utilizing the positional information provided by, for example, the above embodiment, more detailed information about the change in configuration, including the position of vehicles along the length of the consist, may be used to more accurately model the distribution of the vehicle consist and more accurately develop a revised trip plan or other control scheme for the re-configured vehicle consist based on the new configuration.

The entry of change information and re-determination of the trip plan or other control activities may be performed at each stop and/or with each change in the vehicle consist. Each “new” configuration in effect becomes the “initial configuration” or “prior configuration” with respect to future changes.

The setout screen 600 includes directional note 618. Similar to the directional note 542 discussed above, the directional note 618 provides instructions on how to use the screen. In the depicted embodiment, the directional note 618 states, “Use Number Keys To Enter A New Value, Arrow Keys to Change Selection. When Finished, Press F6 or F7 To Continue.” The directional note 618 prompts a user how to enter or select values, and may include, for example, prompts on how to use a corresponding keypad, touch screen, or a combination of the two.

Also generally similar to the above discussion of navigation tabs for the change train screen 500, the setout screen 600 includes navigation tabs 620, 622, and 624. For example, in the depicted embodiment, navigation tab 620, represented by a downwardly pointing arrow, allows a user to scroll downwardly through the various data entry rows, while navigation tab 622, represented by an upwardly pointing arrow, allows a user to scroll upwardly through the various data entry rows. Navigation tab 624 is a backspace function allowing modification of an entry that an operator desires to change.

The illustrated setout screen 600 also includes an information note 626. The information note 626 provides information to an operator and is designed to help clarify or simplify the data entry process. For example, in the depicted embodiment, the information note 626 states “Note: an intermodal five-pack is five cars and single sequence number.” This note thus provides a helpful reminder regarding the entry of sequence and/or car numbers and helps clarify that sequences may have more than one car, which can be helpful regarding the total car entry. Of course, the information note may change, or additional notes may be added as appropriate. For example, if it is learned over time that operators of a particular system have repeated questions or confusion about a particular aspect or aspects of entry and/or display of information, an information note may be added or altered to help address that aspect or aspects. Thus, information notes may be tailored for particular systems, screens, and/or operators, for example.

Similar to those discussed above, the confirmation tabs 628, 630 allow an operator to have the values entered onto the setout screen 600 accepted by, for example, a control unit, where, for example, the newly entered values may be used by a trip planning system to re-calculate and/or adjust the control of the vehicle consist. Confirmation tab 628 is an “Accept” tab that, when selected, accepts the entered information showing on the screen and forwards on to the appropriate systems for use of the newly entered information. Confirmation tab 630 is a “Cancel” tab that, when selected, removes the newly entered information and reverts to the previously entered information. Once a particular sequence or contiguous sequences are removed from the configuration by use of the setout screen 600, the control unit adjusts the stored configuration. If an additional sequence or sequences are to be removed, an operator may then re-access the setout screen 600 and enter the additional information for the additional sequence or sequences, and repeat the process as required, with the control unit adjusting the configuration after each entry. Alternatively or additionally, a setout screen may be provided that allows for a plurality of sequence groups to be entered simultaneously.

Thus, by using an input unit such as setout screen 600, an operator is able to input not only overall changes to a vehicle consist, but also to input information that provides positional information regarding the changes to a vehicle consist configuration, including the removal of vehicles from the consist. This information may then be used by a control unit to revise configurational information regarding the vehicle consist, to re-calculate a trip plan, and/or to control the vehicle consist according to the new configuration, resulting in improved safety and efficiency.

In the depicted embodiment, an additional screen is used to allow for the addition of cars. In alternate embodiments, the pickup and setout screen may be on the same screen or on subscreens or pop-up screens associated with, for example, a general configuration screen.

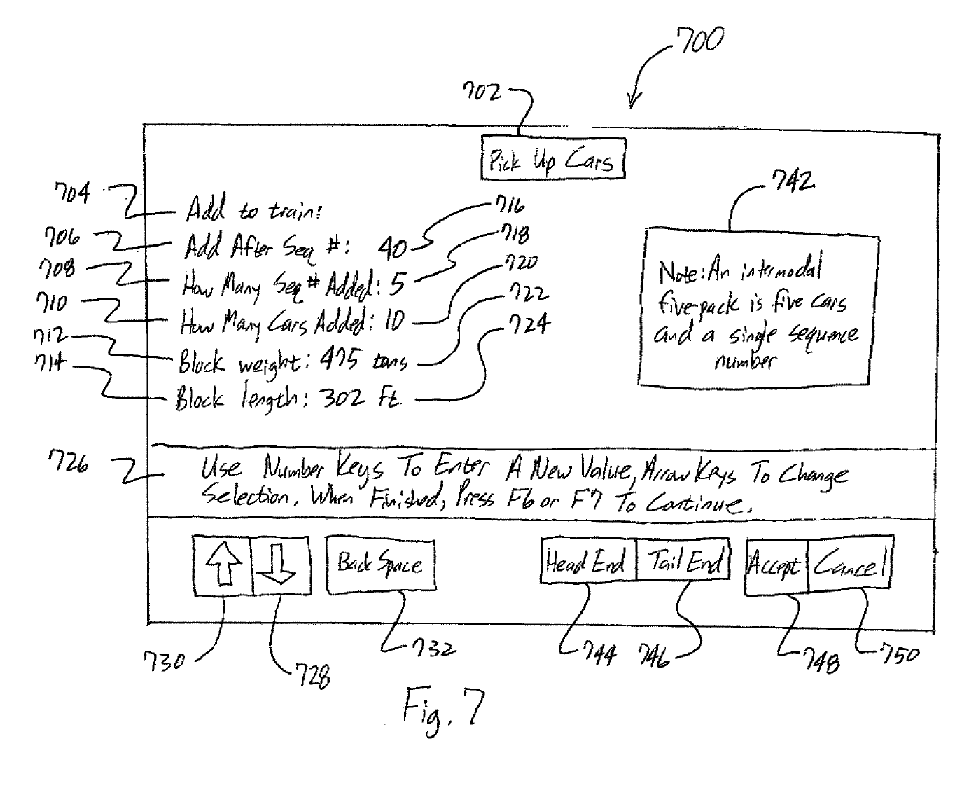

FIG. 7 illustrates an example of a pickup screen 700 formed in accordance with an embodiment. The pickup screen 700 is used to enter information about cars and/or groups of cars that are being added to, or picked up by the vehicle consist. The pickup screen includes a title 702, an addition prompt 704, addition data labels 706, 708, 710, 712, 714, and addition data entries 716, 718, 720, 722, 724. The pickup screen 700 also includes a directional note 726, navigation tabs 728, 730, 732, an information note 742, and confirmation tabs 748, 750. Further, the depicted setout screen 700 includes positional shortcut tabs 744, 746. In alternate embodiments, different amounts and/or forms of data and/or directional notes and/or navigation tabs and/or information notes and/or confirmation tabs may be used. The title 702 is located at the top of the pickup screen 700 and provides a reminder to the operator or data enterer of the function of the screen. In the depicted embodiment, the title 702 is “Pick Up Cars.”

The addition prompt 704 is located at the top of a column of categories for entry of data, and indicates to the operator where to enter the pertinent data. For example, in the depicted embodiment, the pickup screen 700 includes first data label 706 (“Add After Seq #”), second data label 708 (“How Many Seq # Added”), third data label 710 (“How Many Cars Added”), fourth data label 712 (“Block weight”), and fifth data label 714 (“Block length”). Each data label 706, 708, 710, 712, and 714 has a corresponding data entry 716, 718, 720, 722, and 724. In alternate embodiments, additional or different data categories, labels, and/or entries may be used, with more, less, or different forms of information entered.

For example, in the illustrated embodiment, the first data entry 716, which corresponds to the first data label 706, has been entered with a “40,” indicating that there will be newly entered data adding sequences to the configuration after sequence number 40. Again, from above, a system associated with the vehicle consist (such as a control unit discussed above) would already have the information to identify and describe the location of sequence 40, and would be configured to re-set the configuration of the vehicle consist by adding the appropriate cars after sequence 40.

In the illustrated embodiment, the second data entry 718, which corresponds to the second data label 708, has been entered with a value of “5,” indicating that 5 sequences are to be added. If, for example, sequence 40 was previously at the very end, or tail, of the vehicle consist, the additional sequences could be added at the rear of the vehicle consist. As another example, if sequence 40 were in the middle of the vehicle consist, the vehicle consist could be re-configured so that previous sequence 41 would become sequence 46 (i.e. 41 plus 5). Other organizational schemes could be employed, so long as the configuration prepared and/or used by the control system accurately reflected the actual physical configuration of the vehicle consist.

For example, arbitrary sequence numbers could be assigned to the newly added sequences, as long as those sequences were placed between previous sequences 40 and 41. Sequence numbers thus could be re-assigned at each configuration, or new sequence numbers added (or removed) so that the sequence numbers may not necessarily proceed in order.

As another example, in other embodiments, the information may be entered one sequence at a time, or even one vehicle at a time, which can provide for addition of more specific data about each particular sequence or vehicle. As another example, the information may be initially entered via a screen such as screen 700, having a first, less detailed information group, and later supplemented by, for example, an automated scan or other automated data entry unit providing additional information on the particular sequences and/or vehicles, thereby providing a second, more detailed information group on the same vehicles, thereby allowing for a more detailed representation of the configuration of the consist at some later time than the entry of information by an operator. The additional information may be used to supplement and/or replace information entered by the operator, providing an updated representation of the vehicle consist configuration, and may be used to re-calculate a trip plan or other control plan.

Further still, in the illustrated embodiment, the third entry 720, which corresponds to the second data label 710, has been entered with a “10,” indicating that the five sequences added have a total of ten cars. In this particular embodiment, the 5 sequences (having ten cars) are entered as a block positioned immediately behind sequence 40. In the depicted embodiment, the 5 added sequences are seen as a block behind sequence 40. Thus, there may be less detailed information about the precise distribution of weight within the newly added block than was provided for example, for cars and/or sequences in the initial configuration (which may, for example, have car-by-car distribution information). The added positional information, however, still provides for improved re-calculation or adjustment of the consist configuration and/or related control plan than certainly presently known systems where no positional information is provided at setouts or pickups. In other embodiments, more detailed sequence-by-sequence or car-by-car information may be entered providing still greater accuracy in the re-calculation.

In determining the amount of information to be added at pickup entry or other entry scheme reflecting additions to the vehicle consist, the amount of information added may be based on a combination, or balancing, of convenience and accuracy. The more detailed information about the weight distribution of each car and/or sequence, provides for a more detailed representation of the configuration, but may require additional time for entry and/or additional opportunity for error or mis-entry of each piece of entered information. Entering less information may provide a less detailed configuration and re-calculation, but provides for quicker operator entry and less opportunity for entry error.

For example, in an embodiment using a pickup screen such as pickup screen 700, a control system may initially have, or have access to, car-by-car weight distribution information used to originally prepare the vehicle consist configuration representation, and calculate a trip plan using the originally provided detailed information. However, with the data entered as on screen 700, some loss of car-by-car detail is lost, relative to the other portions of the initially configured vehicle consist, because the 5 new sequences are entered as a block. Nevertheless, because the new information still includes distributional information for the newly added sequences (e.g. their position within the consist behind sequence 40) and overall weight and length of the newly added sequences, a new configuration of the vehicle consist may still be prepared with improved accuracy over a prior art system that would not include such positional or distributional information. (Note that this loss of relative specificity for change information does not occur with removed sequences, as the system would still retain the information for the remaining cars and/or sequences).

Further, the fewer the number of additions and the smaller the number of additions is relative to the overall consist length, the less effect the loss of specificity or detail for certain blocks or portions of the consist will have. Other embodiments may have improved specificity by entering data sequence by sequence, or car by car, or other higher level of detail. As also indicated above, still other embodiments may allow for the addition of information at a first level of detail as by screen 700, which is supplemented automatically at a later time by a scanning or other automated process. For example, the information at screen 700 may be entered, the configuration updated, and the trip plan re-calculated based on the new configuration and information, providing for improved planning. Then, at a later time, information at a second, higher level of detail, from an automated data entry unit, may provide more specific information about the sequences added via screen 700, allowing for a more detailed re-configuration and re-calculation. The automated data entry unit may be associated with a data system external to the vehicle consist or associated systems, with the control unit allowed access to the external data system to obtain the more detailed information. Thus, a system using screen 700 may communicate with other systems as well to obtain information, or, in other embodiments, may additionally or alternatively provide information regarding the vehicle consist configuration to other systems.

Further, if the sequences forming a block of sequences added at once are not removed at the same time (for example if a sub-group of a block entered at once is removed at an intermediate stopping point), the sequence information may no longer be as accurate as previously provided. This may be avoided, for example, by removing the entire sequence and re-entering only the remaining sequences and/or cars. For example, if the system detects that only a portion of a group of sequences and/or cars added as a block are later being removed, the system may provide a prompt to an operator during the removal of those sequences and/or cars. For example, the prompt may be a note (pop-up or otherwise) indicating that the entire block should be removed and only the remaining cars from the block re-entered. In other embodiments, the prompt may direct the operator to make car by car entries for the remaining cars. In still other embodiments, the prompt may merely be an alert informing the operator that the configuration will not be entirely correct, which may not require further action if the effect of the change is negligible. The additional information may be known to the operator, for example, from the paperwork associated with each addition or removal of sequences and/or cars, and may be readily available for more detailed entry.

The fourth data entry 722, which corresponds to the fourth data label 712, is “475 tons” in the illustrated embodiment. This indicates that, for the 5 sequences (having a total of ten cars) the combined weight is 475 tons. The control system can use this information to position a 475 ton block where the new sequences are being added, allowing for positioning of the weight of the added sequences. This data category, additionally or alternatively to the fifth data entry 724 (“Block length”), may also serve as a useful double-check on the sequence data being entered. For example, the control system may have access to information regarding the sequences to be added, and compare that information to the information entered by the operator. Then, the control system, using information accessed regarding the newly added cars, can double-check the operator's entry and provide a prompt if the entries are inconsistent. Or, in other embodiments, a control system may automatically fill out the block weight entry based on the entered sequences allowing the operator to visually check for confirmation, and/or may provide a prompt asking the operator whether or not the automatically filled in information is correct.

Similarly, the numbers of cars added information may be entered along with a beginning sequence number, with the control system automatically filling in the other sequence number, and/or requesting confirmation (for example, by a pop-up screen) from the operator of the automatically filled in number. Similar calculations and automatic fill-in of entries by a control unit may be performed for additional or alternative entries in different embodiments. Then, the information regarding the number, position, and/or weight of the added sequences and/or cars may be displayed for confirmation by the operator. Confirmation may also be obtained additionally or alternatively through the use of the confirmation tabs 748 and 750 discussed below. Thus, an operator may enter all of the data entries on a given screen or user interface, or, in other embodiments, certain of the entries may be automatically filled by an associated system, unit or processor.

The fifth data entry 724, which corresponds to the fifth data label 714, is “302 ft.” in the illustrated embodiment. This indicates that the newly added sequences are 302 feet in total length. In the depicted embodiment, this information allows for both approximating the weight distribution of the added cars, as well as positioning any sequences located behind the newly added sequences. For example, the control system may approximate the weight distribution for the block by treating the weight as being evenly distributed, and dividing the “475 tons” uniformly along the “302 ft.” length. Of course, other distribution estimates may be used. Or, if more detailed distribution information is required or desired, then more detailed information, such as sequence by sequence or car by car, may be added, as appropriate. As discussed above, this or other categories of data may be used to double-check other entries, and may be confirmed and/or verified with information available to the control system by additional sources.

It should be kept in mind that other input units are possible, either automatic, used by an operator, or some combination of automatic and operator entry. Multiple input devices may be used in the same system, and data entered by one input device may supplement and/or confirm data entered by other input devices.

The first data entry 716 and fifth data entry 724, for example, contain positional or distributional, information. By identifying a specific sequence number associated with positions in the existing configuration of the vehicle consist after which the new sequences are added, as well as providing information on the length and/or weight of the newly added sequences, these positional data entries provide positional information that allows the control system to adjust to the new configuration not only by adjusting for a change in length and/or weight, but also in the position, or distribution of the lengths and weights of the various cars associated with the new configuration.

For example, as also discussed above, in systems where a trip plan is calculated based on the distribution information of a vehicle consist, aspects of that information may become lost if only entries in overall length and weight of the vehicle consist are entered. However, utilizing the positional information provided by, for example, the above embodiment, more specific information about the change in configuration, including the position and distribution of vehicles added to the consist, may be used to more accurately know the distribution of the vehicle consist and more accurately calculate a revised trip plan for the re-configured vehicle consist based on the new configuration.

As indicated above, the amount and format of the information regarding the change to the configuration of a vehicle consist can vary, for example, based on balancing considerations of convenience of entry versus completeness of information. Similarly, multiple formats for data entry may be used alternatively or additionally. For example, in certain embodiments, information on added or removed sequences may be entered in by work order identification. Such an identified (and anticipated) work order may correspond to information pre-loaded into the control system and/or accessible by the control system. However, if the work order information does not match with a pre-stored work order (due for example, in an error in the initially entered work order, or a change made to the work order subsequent to its entry into a data storage system), the control unit may provide a prompt alerting an operator of the inconsistency, and/or an alternate data entry method may be employed.

The pickup screen 700 also includes the directional note 726. Similar to the directional notes 542 and 618 discussed above, the directional note 726 provides instructions on how to use the screen. In the depicted embodiment, the directional note 726 states, “Use Number Keys To Enter A New Value, Arrow Keys to Change Selection. When Finished, Press F6 or F7 To Continue.” The directional note 7266 prompts a user how to enter or select values, and may include prompts, for example, on how to use a corresponding keypad, touch screen, or a combination of the two.

Also generally similar to the above discussion of navigation tabs for the setout screen 600, the pickup screen 700 includes navigation tabs 728, 730, and 732. For example, in the depicted embodiment, navigation tab 728, represented by a downwardly pointing arrow, allows a user to scroll downwardly through the various data entry rows, while navigation tab 730, represented by an upwardly pointing arrow, allows a user to scroll upwardly through the various data entry rows. Navigation tab 730 is a backspace function allowing modification of an entry that an operator desires to change. Other navigation tabs may be employed to navigate along any particular screen or data entry unit, and/or to navigate between different screens or data entry units.

The illustrated pickup screen 700 also includes an information note 742. The information note 742 provides information to an operator and is designed to help clarify or simplify the data entry process. For example, in the depicted embodiment, the information note 742 states “Note: an intermodal five-pack is five cars and single sequence number.” This note thus provides a helpful reminder regarding the entry of sequence and/or car numbers and helps clarify that sequences may have more than one car, which can be helpful regarding the total car entry. Of course, the information note may change, or additional notes may be added as appropriate. For example, if it is learned over time that operators of a particular system have repeated questions or confusion about a particular aspect or aspects of entry and/or display of information, an information note may be added or altered to help address that aspect or aspects. As another example, in embodiments utilizing entry by work order entry, an information note may provide useful information regarding how to enter work order information compared to other types of data entry. Additionally or alternatively, information notes may be provided in response to certain types of data entry or responsive to data entries that are determined by the control system to be inconsistent or incorrect. Thus, information notes may be tailored for particular systems, screens, and/or operators, for example.

The depicted pickup screen 700 also includes shortcut tabs. These are examples of a specific position entry module, providing a method by which an operator may more quickly, easily, and/or accurately enter positional information. The shortcut tabs in the depicted embodiment include a head end tab 744 and a tail end tab 746. The head end tab 744, when selected (for example, by pressing an appropriate portion of a touch screen, or identifying a portion of the screen using an arrow controlled by a cursor), places the new sequence or sequences to be added at a pre-selected head or lead position of the vehicle consist, for example immediately behind a lead locomotive. Similarly, the tail end tab 746, when selected, places the new sequence or sequences at the rear, or tail end of the vehicle consist. The control unit then assigns appropriate identifiers (such as, for example, sequence numbers) to the added vehicles, and determines an updated configuration of the consist. Thus, the selection of a shortcut tab, or use of a similar specific position entry module, allows an operator to immediately assign a new sequence or sequences to a previously assigned location within the vehicle consist, such as the head or tail end.

Use of such specific position entry modules provides several benefits. For example, when using a specific position entry module, the identifying number of a sequence at a given position, such as the tail or head end, need not be known or looked up from a previous configuration. Also, use of a specific position entry module, such as a “head end” or “tail end” shortcut tab reduces the risk of an entry error, such as by typing in an incorrect sequence number when describing the location of the newly added sequence or sequences. Further, the specific position entry modules provide for added convenience. To help avoid potential mis-entry of sequence numbers, the specific position entry modules may override, for example, an entry in an “Add After Seq #” data category. Alternatively or additionally, the specific entry modules may provide a double-check on such entries, with the control system prompting an operator in the event of an inconsistency between the entries. Such specific position entry modules, such as shortcut tabs as discussed above, may also be used, for example, with a setout screen and/or a combination screen allowing for both setout and pickup of sequences.

Other types of data than that shown for the above discussed screens may be entered in certain embodiments. For example, information regarding a type or configuration of a car or cars within a sequence may be added. For example, safety information may be entered, such as a designation of a specific type of car for which positional safety considerations should be considered. One type of car with positional safety implications is a car containing flammable gas. It may be unwise (or against regulations) to position such cars in certain positions within a consist, for example, immediately behind a locomotive, or as another example, at the rear of a vehicle consist.

With positional information describing the location of a flammable gas car, as well as vehicle type information describing the content of such a car, available to the control system, the control system may, by analyzing the configuration with respect to pre-set rules, determine when an unsafe condition exists (for example, when the configuration includes a flammable gas car in an unsafe position, such as at the rear end of the vehicle consist). The control system may, as appropriate, then issue an inconsistency response indicative of an inconsistency between the configuration and a pre-set rule. The inconsistency response may comprise, for example, a prompt advising an operator of the unsafe condition, or in other embodiments, the control system may prohibit the vehicle consist from moving until the positional safety concern is rectified.

Other types of positional warnings may be based on issues or concerns regarding convenience, handling and/or efficient operation. For example, if the control system, based on a new configuration caused by the addition or subtraction of cars, determines that the vehicle consist is more heavily back-weighted than desirable, an inconsistency response may be provided indicating an inconsistency between the configuration and a pre-set rule setting a threshold on rear weight distribution. For example, a prompt may be provided providing the option of re-configuring. Of course, in many situations the effort to physically re-configure the cars may not be worth the handling improvement, or in other situations, the benefits of certain positions for sequences of cars may provide for greater convenience for subsequent planned setouts or pickups. For example, in some situations a configuration that is somewhat less desirable handling-wise may nonetheless be a more desired configuration for overall convenience.

Other information, such as coupler type, may also be entered, along with the positional information identifying the location of a vehicle or sequence. Still other car specific information may also be provided, in addition to, for example, weight, coupler type, or safety information.

For example, information regarding the type or design of car may be provided. As one example, certain types of cars are known to present handling or efficiency issues when positioned at the rear of a vehicle consist. For example, bulkhead flat cars are configured as flat cars with frames extending upward along the middle of the car for the length or a substantial portion of the length of the car. When empty, these cars can exhibit a sail-like behavior and be subject to wind effects. If a number of such empty bulkhead flat cars are positioned toward the rear of a vehicle consist, the resulting wind effects may negatively affect the handling of the vehicle consist. Thus, if the control system, based on the positional information and car specific information provided, determines that a new configuration poses such difficulties, based on a comparison with a pre-set rule regarding the placement of such cars, an inconsistency response may be provided. For example, a prompt may be issued informing an operator or administrator of the issue, and allowing the option of re-configuring the cars before proceeding. Further, to the extent changes to the consist are known in advance, from work orders or otherwise, the control unit may be configured to anticipate future configurations and provide prompts describing potential re-configurations to improve, for example, safety or handling.

Thus, certain embodiments combine information regarding vehicle specific information regarding a vehicle or vehicles in a consist along with positional information regarding the vehicle or vehicles, and determine the consistency of the resulting consist configuration with rules to identify potential safety and/or handling issues present in the configuration of a vehicle consist. This analysis may be performed before and/or after the confirmation of the proposed addition or subtraction of vehicles, and may result in, for example, issuance of a prompt providing an option to re-configure, and/or prohibition of movement before re-ordering of the vehicles in the consist (for example, due to a safety consideration).

Yet one more example of change information can be if a vehicle remains in a consist but is unloaded. For such a change, the change in actual or estimated weight may be entered associated with the position of the vehicle and/or sequence containing the vehicle within the consist.

Similar to those discussed above, the confirmation tabs 748, 750 allow an operator to have the values entered onto the pickup screen 700 accepted by the control system, where, for example, they may be used by a trip planning system to re-calculate and/or adjust the control of the vehicle consist. Confirmation tab 748 is an “Accept” tab that, when selected, accepts the entered information showing on the screen and forwards on to the appropriate systems for use of the newly entered information. Confirmation tab 750 is a “Cancel” tab that, when selected, removes the newly entered information and reverts to the previously entered information.

Thus, by using an input unit such as pickup screen 700, an operator is able to input not only overall changes to a vehicle consist, but also to input information that provides positional information regarding the changes to a vehicle consist configuration. This information may then be used by a control unit to revise configuration information regarding the vehicle consist, to re-calculate a trip plan or other control scheme based at least in part on the configuration of the consist, and to control the vehicle consist according to the new configuration, resulting in improved safety and efficiency.

A given individual stop of the vehicle consist may involve multiple entries, such as for example, one or more setouts and/or one or more pickups. Further, a consist may pass through multiple stops as it progresses along its route to its end destination. Information regarding the various stops, including setouts and pickups, can be added after each change, and the control unit can recalculate and reconfigure the consist configuration after each entry.

Further, the updated information and updated consist configuration may be distributed to different systems in addition to the control system of a given vehicle and/or consist. Such systems may be internal to the consist or external to the consist. Such systems receiving information may for example, be associated with the scheduling of other consists that may share a track or tracks with the consist, or associated with the assignment of tracks to the consist or other consists. Further, the information may be provided to other systems, for example, to allow for confirmation and/or validation of the entered information, or, as another example, for record keeping such as tracking the location of a consist or vehicles within a consist.

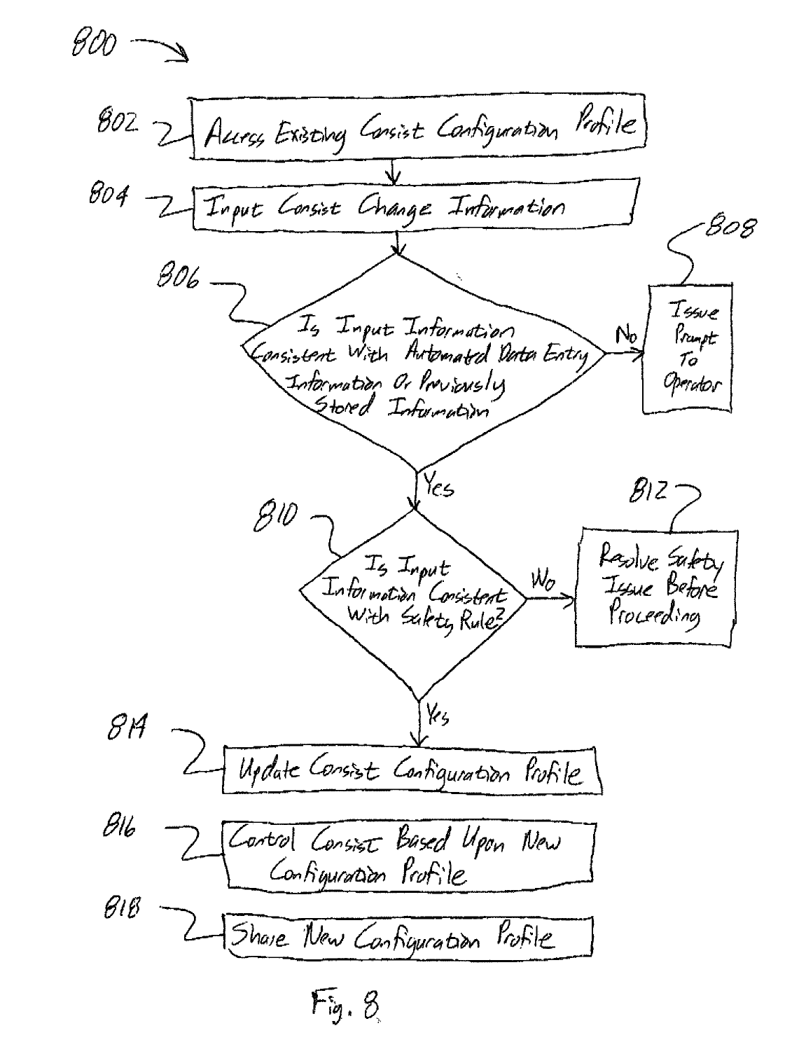

FIG. 8 illustrates an embodiment of a method 800 for controlling a vehicle consist. In certain embodiments, certain steps may be added or omitted, certain steps may be performed simultaneously with other steps, certain steps may be performed in different order, and certain steps may be performed more than once, for example, in an iterative fashion.

The method 800 begins with step 802, accessing an existing consist configuration profile. The existing consist configuration, for example, may contain a car-by-car or sequence-by-sequence configuration of the vehicle consist. The existing consist configuration may be an initial configuration at the beginning of a consist's journey, or may be a configuration that has been updated at previous stops where changes were made to the consist configuration.

At step 804, consist change information is input at an input unit. For example, the consist change information, or at least a portion of the consist change information may be input by an operator at an operator user interface. The consist change information describes changes made to a vehicle consist and includes positional information describing at least one location of a change to the vehicle consist. For example, the consist change information may include information regarding the length, weight, and/or type of vehicle or vehicles in a sequence being added (or removed) from a consist as well as a sequence identifier (or identifiers) placing the location of the change within the consist. The consist change information, while including positional information, may nonetheless be at a lower level of detail than the information included in the existing, or previous, configuration profile.

At step 806, the consist change information is compared with information obtained via either an automated data entry unit or information previously stored in an accessible data unit regarding the change. For example, if the consist change information has been stored as part of a pre-configured work order, the entered information may be compared with the pre-stored information for consistency. If the user interface-entered consist change information is inconsistent with the automated data entry unit information and/or previously stored information, the process progresses to step 808 for appropriate processing, such as the issuing of a prompt to the operator of the inconsistency so that the inconsistency may be addressed and/or resolved.

At step 810, the consist change information is analyzed for consistency with at least one rule. For example, the rule may be a safety rule, such as a rule regarding the allowable position of a flammable gas car. If the consist change information is consistent with the rule, the process may proceed to step 814. If not, the process proceeds to step 812 where the consist is not allowed to proceed until the safety issue is satisfactorily resolve. At step 812, for example, the control unit may provide a screen similar in certain respects to screen 900 (discussed below), however the message block may state that the consist may not proceed due to a specified safety concern, and the operator may not be provided with the option of proceeding, for example, depending on a threat or danger level associated with the safety issue.

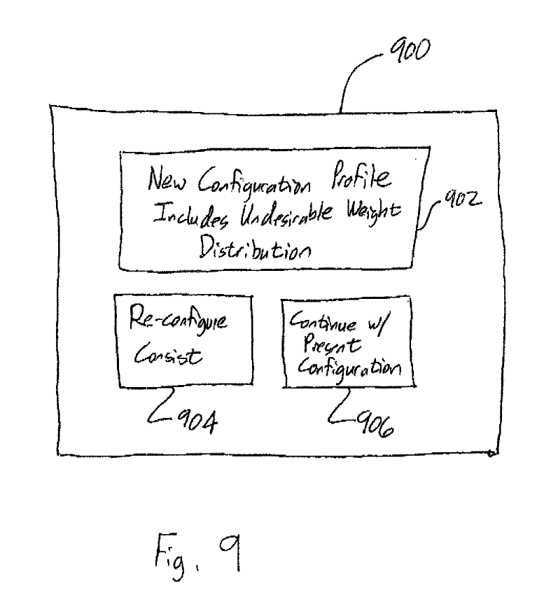

In embodiments, the at least one rule may related, for example, to handling concerns or issues. For example, FIG. 9 illustrates an embodiment of a prompt screen 900 issued in response to an inconsistency with a rule regarding consist handling. The screen 900, for example, may be a popup screen on a display associated with an input unit, In FIG. 9, the prompt indicates, via a message block 902 that the new configuration profile has an undesirable weight distribution, for example with more weight than desired toward the rear. This inconsistency may be acceptable in terms of allowing the consist to proceed, so the prompt of FIG. 9 may alert the operator to the situation but allow the operator to choose between re-positioning vehicles in the consist by selecting (for example, with a touch screen or with an arrow controlled by a cursor) a re-configure tab 904, or to continue as configured by selecting a continue tab 906.

Next, at step 814, the existing, or previous, consist configuration profile is updated, based on the consist change information, to a new consist configuration profile. As discussed above, the previous consist configuration profile may be updated only with respect to the aspects of the consist being changed, with unaffected portions retaining previous associated information. The previous and new consist configuration profiles both include information regarding vehicles or sequences of vehicles in the consist along with the location of the vehicles or sequences of vehicles.

At step 816, the operation of the vehicle consist is controlled based upon the new configuration profile. For example, a trip plan or other control scheme or plan based upon the configuration of the vehicle consist may be re-calculated or otherwise re-determined or updated. At step 818, the new configuration profile is shared with a system external to the vehicle consist. For example, the new configuration profile may be shared with an external system that may utilize the updated profile for planning purposes and/or evaluation of the determined configuration profile for consistency.

In one embodiment, a system comprises a control unit and an input unit. The control unit is configured to interface with a first vehicle located in a vehicle consist having a plurality of vehicles, and to generate first control signals for controlling at least one of the first vehicle or the vehicle consist based on a stored consist configuration data set that is representative of a configuration of the vehicles in the vehicle consist. The stored consist configuration data set includes information regarding a distribution of the vehicles in the vehicle consist. The input unit is operably coupled to the control unit, and is configured for input of consist change information that includes positional information representative of a location of at least one change in the vehicle consist. The control unit is configured to receive consist change information from the input unit. The control unit is configured to use the consist change information to update the stored consist configuration data set to generate an updated stored consist configuration data set, and to generate additional, second control signals for controlling the operations of the at least one of the first vehicle or the vehicle consist based on the updated stored consist configuration data set. The location of the change that is included in the consist change information may represent the actual location in the consist in which the change occurs. For example, the location may represent where a vehicle was removed from the consist, where a vehicle was added to the consist, where cargo or passengers were removed from the consist, and/or where cargo or passengers were added to the consist.

In one aspect, the input unit comprises a user interface configured to allow an operator of the vehicle consist to manually enter at least a portion of the consist change information. Further, the user interface may include a specific position entry module configured to allow an operator to assign a newly added vehicle or vehicles to a previously assigned location within the vehicle consist. Additionally or alternatively, the system may include an automated data entry unit configured to enter information representative of at least some of the consist change information, with the control unit configured to use the information entered by the automated data entry unit to at least one of supplement, confirm, or replace information entered via the user interface.

In one aspect, the control unit is configured to analyze the updated stored consist configuration data set with respect to at least one rule for operating the vehicle consist. The control unit is configured to provide an inconsistency response if the updated stored consist configuration data set is inconsistent with the at least one rule. For example, the at least one rule may comprise a safety rule, with the control unit configured to prevent operation of the vehicle consist if the safety rule is not satisfied. As another example, the control unit may be configured to provide a prompt to an operator or administrator of the vehicle consist informing the operator or administrator of inconsistency between the updated stored consist configuration data set and the at least one rule.

In one aspect, the consist change information includes data describing at least one vehicle being added to or removed from the vehicle consist and positional information regarding a location at which the at least one vehicle being added to or removed from the vehicle consist is actually added to or removed from the vehicle consist.

In one aspect, the control unit is configured to confirm the accuracy of at least a portion of the consist change information by at least one of performing a calculation, or comparing the at least a portion of the consist change information to previously stored information.

In one aspect, the consist change information is less detailed than a corresponding portion of the stored consist configuration data set.

In one aspect, the consist change information relates to less than an entirety of the stored consist configuration data set.

In one aspect, the consist change information relates to less than an entirety of the vehicle consist.

In one embodiment, a method includes receiving, via an input unit, consist change information. The consist change information includes positional information representative of at least one location of a change to a vehicle consist. The method also includes updating, at a control unit of a vehicle of the vehicle consist, a previous configuration profile of the vehicle consist. The update is based on the consist change information to provide a new configuration profile. The previous and new configuration profiles include information regarding at least one of a distribution of vehicles or sequences of vehicles in the vehicle consist. The method further includes controlling the vehicle consist based on the new configuration profile.

In one aspect, at least a portion of the consist change information is received via manual in put at an operator user interface. Further, the method may include comparing the at least a portion of the consist change information received at the operator user interface with at least one of information entered at an automatic data entry unit or information previously stored.

In one aspect, the method may include analyzing, at a control unit of the vehicle consist, the new configuration profile for consistency with at least one rule. For example, the method may comprise preventing the vehicle consist from proceeding if the new configuration profile is inconsistent with a safety rule.

In one aspect, the consist change information comprises data describing at least one vehicle being added to or removed from the vehicle consist and positional information representative of a location at which the at least one vehicle is actually added to or removed from the vehicle consist.

In one aspect, the method further comprises communicating the new configuration profile to a system external to the vehicle consist.

In one aspect, the consist change information relates to less than an entirety of the vehicle consist.

In one embodiment, a non-transitory computer readable storage medium contains one or more sets of instruction that when executed by a control unit of a vehicle, cause the control unit to receive, via an input unit, consist change information that includes positional information representative of at least one location of a change to a vehicle consist including the vehicle. The control unit is also caused to update, based on the consist change information, a previous configuration profile of the vehicle consist to a new configuration profile. The previous and new configuration profiles comprise information regarding at least one of a distribution of vehicles or sequences of vehicles in the vehicle consist. The control unit is further caused to control the operation of the vehicle consist based on the new configuration profile.

In one aspect, at least a portion of the consist change information is received from an operator user interface at which the at least a portion of the consist change information has been entered manually. Further, the control unit may also be caused to compare the at least a portion of the consist change information received from the operator user interface with at least one of information entered at an automatic data entry unit or information previously stored.

In one aspect, the control unit is caused to analyze the new configuration profile for consistency with at least one rule. Further, the control unit may additionally be caused to prevent the vehicle consist from proceeding if the new configuration profile is inconsistent with a safety rule.

In one aspect, the consist change information relates to less than an entirety of the vehicle consist.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

Since certain changes may be made in the above-described systems and methods for controlling a vehicle consist, without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

1. A system comprising:
a control unit configured to interface with a first vehicle in a vehicle consist having a plurality of vehicles, wherein the control unit is configured to generate first control signals for controlling operations of at least one of the first vehicle or the vehicle consist based on a stored consist configuration data set that is representative of a configuration of the vehicles in the vehicle consist, the stored consist configuration data set comprising information regarding a distribution of the vehicles in the vehicle consist; and
an input unit operably coupled with the control unit, the input unit configured for input of consist change information that includes positional information representative of a location of at least one change in the vehicle consist;
wherein the control unit is configured to receive the consist change information from the input unit, to use the consist change information to update the stored consist configuration data set to generate an updated stored consist configuration data set, and to generate additional, second control signals for controlling the operations of the at least one of the first vehicle or the vehicle consist based on the updated stored consist configuration data set.

2. The system of claim 1, wherein the input unit comprises a user interface configured to allow an operator of the vehicle consist to manually enter at least a portion of the consist change information.

3. The system of claim 2, wherein the user interface includes a specific position entry module configured to allow an operator to assign a newly added vehicle or vehicles to a previously assigned location within the vehicle consist.

4. The system of claim 2, further comprising an automated data entry unit configured to enter information representative of at least some of the consist change information, wherein the control unit is configured to use the information entered by the automated data entry unit to at least one of supplement, confirm, or replace information entered via the user interface.

5. The system of claim 1, wherein the control unit is configured to analyze the updated stored consist configuration data set with respect to at least one rule for operating the vehicle consist, and to provide an inconsistency response if the updated stored consist configuration data set is inconsistent with the at least one rule.

6. The system of claim 5, wherein the at least one rule comprises a safety rule, and the control unit is configured to prevent operation of the vehicle consist if the safety rule is not satisfied.

7. The system of claim 5, wherein the control unit is configured to provide a prompt to an operator or administrator of the vehicle consist informing the operator or administrator of inconsistency between the updated stored consist configuration data set and the at least one rule.

8. The system of claim 1, wherein the consist change information comprises data describing at least one vehicle being added to or removed from the vehicle consist and positional information regarding a location at which the at least one vehicle being added to or removed from the vehicle consist is actually added to or removed from the vehicle consist.

9. The system of claim 1, wherein the control unit is configured to confirm at least a portion of the consist change information by at least one of:
performing a calculation; or
comparing the at least a portion of the consist change information to previously stored information.

10. The system of claim 1, wherein the consist change information is less detailed than a corresponding portion of the stored consist configuration data set.

11. The system of claim 1, wherein the consist change information relates to less than an entirety of the stored consist configuration data set.

12. The system of claim 1, wherein the consist change information relates to less than an entirety of the vehicle consist.

13. A method comprising:
receiving, via an input unit, consist change information that includes positional information representative of at least one location of a change to a vehicle consist having a plurality of vehicles;
updating, based on the consist change information, a previous configuration profile of the vehicle consist to provide a new configuration profile, wherein the previous and new configuration profiles comprise information regarding at least one of a distribution of vehicles or sequences of vehicles in the vehicle consist; and
controlling the operation of the vehicle consist based on the new configuration profile.

14. The method of claim 13, wherein at least a portion of the consist change information is received via manual input at an operator user interface.

15. The method of claim 14, further comprising comparing the at least a portion of the consist change information received at the operator user interface with at least one of information entered at an automatic data entry unit or information previously stored.

16. The method of claim 13, further comprising analyzing, at a control unit of the vehicle consist, the new configuration profile for consistency with at least one rule.

17. The method of claim 13, further comprising preventing the vehicle consist from proceeding if the new configuration profile is inconsistent with a safety rule.

18. The method of claim 13, wherein the consist change information comprises data describing at least one vehicle being added to or removed from the vehicle consist and positional information representative of a location at which the at least one vehicle is actually added to or removed from the vehicle consist.

19. The method of claim 13, further comprising communicating the new configuration profile to a system external to the vehicle consist.

20. The method of claim 13, wherein the consist change information relates to less than an entirety of the vehicle consist.

21. A non-transitory computer readable storage medium containing one or more sets of instruction that when executed by a control unit of a vehicle, cause the control unit to:
receive, via an input unit, consist change information that includes positional information representative of at least one location of a change to a vehicle consist having a plurality of vehicles including the vehicle;
update a previous configuration profile of the vehicle consist, based on the consist change information, to provide a new configuration profile, wherein the previous and new configuration profiles comprise information regarding at least one of a distribution of vehicles or sequences of vehicles in the vehicle consist; and
control the operation of the vehicle consist based on the new configuration profile.

22. The non-transitory computer readable storage medium of claim 21, wherein at least a portion of the consist change information is received from an operator user interface at which the at least a portion of the consist change information has been entered manually.

23. The non-transitory computer readable storage medium of claim 22, wherein the control unit is further caused to compare the at least a portion of the consist change information received from the operator user interface with at least one of information entered at an automatic data entry unit or information previously stored.

24. The non-transitory computer readable storage medium of claim 21, wherein the control unit is further caused to analyze the new configuration profile for consistency with at least one rule.

25. The non-transitory computer readable storage medium of claim 24, wherein the control unit is further caused to prevent the vehicle consist from proceeding if the new configuration profile is inconsistent with a safety rule.

26. The non-transitory computer readable storage medium of claim 21, wherein the consist change information relates to less than an entirety of the vehicle consist.
